(19) United States
(12) Patent Application Publication
(10) Pub. No.: US 2022/0242798 A1
(43) Pub. Date: Aug. 4, 2022

(54) Amino Acid Fertilizer, Feed, and Soil Amendment Made From Blood and Feathers

(71) Applicant: Robert W Beachy, Charlottesville, VA (US)

(72) Inventor: Robert W Beachy, Charlottesville, VA (US)

(21) Appl. No.: 17/649,796

(22) Filed: Feb. 2, 2022

Related U.S. Application Data
(60) Provisional application No. 63/144,712, filed on Feb. 2, 2021.

(51) Int. Cl. C05F 1/00; C05F 17/40; C05F 17/60; C05F 17/10; C05F 17/20; C05F 17/957; C05F 17/986; C05G 1/00; C05G 5/20

(52) U.S. Cl. CPC C05F 1/005; C05F 17/40; C05F 17/60; C05F 17/10; C05G 5/20; C05F 17/957; C05F 17/986; C05G 1/00; C05F 17/20

(57) ABSTRACT

The disclosed product is an organic commercial 4-0-1 (nitrogen, phosphate, potash) fertilizer or soil mmendment and a feed that can be used as a liquid or dried and used alone or combined with other feeds. Examples of use are feed for black fly larva and all insects, chickens and other foul, all fish, mammals, reptiles, crustaceans; basically, most all living things and microorganisms. This product can be safely used around water because it is suitable as food for fish, reptiles, invertebrates and amphibians.

### FIELD OF THE INVENTION

An amino acid product for use as a fertilizer, feed, and/or soil amendment is disclosed using products that are normally considered waste material.

### BACKGROUND OF THE INVENTION

Organic products are the fastest growing sector of the U.S. food industry. Organic food sales continue to increase by double digits annually, far outstripping the growth rate for the overall food market. Organic fertilizers, animal feeds, and soil amendments, like organic food, are growing faster than their synthetic counterparts.

Unlike conventional fertilizers, amino acids can be utilized by the plant through foliar, root, and hydroponic fertilization with increased fertilizer utilization. Amino acids need less water for the function of the plant in photosynthesis. Amino acids require little to no interaction with bacteria or fungus to provide similar plant growth and vigor. Unlike any other fertilizers, this product can be safely used around water because it is suitable as food for fish, reptiles, invertebrates, and amphibians.

### SUMMARY OF INVENTION

A method of producing a product for use as a fertilizer, feed, and soil amendment by breaking down proteins to amino acids is disclosed. Liquid, blood or a combination of blood and water, is placed in a tank system containing a heater and an agitator and being able to be pressurized to at least 1-2 atmospheres. Although more than one tank is preferable, a single tank can be used. The liquid is agitated and heated to an initial temperature of 30°-40° C. to prevent blood coagulation. Once the temperature is reached, keratin, is added to the liquid until the mixture composition is 1-40% blood and 60%-99% feathers. Once the mixture is thoroughly combined, the moisture content of the mixture is obtained from a sample. The preferred moisture content is in the range of 58%-62%. If the mixture does not have desired moisture content, water can be added to achieve the moisture content. The keratin can be from any source and in some instances, such as feathers, must be hydrolyzed and pressed prior to addition to the liquid. The hydrolyzation and pressing reduces moisture content and the fat content of the feathers. When heavier density feathers, such as turkey, sodium sulfite can be added to assist in the breakdown process.

Once the keratin is added and the moisture content is within the 58%-62% range, the temperature is raised to 64°-70°. The fat level of the mixture is tested to determine whether the addition of lipase is required. The lipase will force the fat into the mixture rather than its resting on the top. The pH level is raised to 8.9 to 9.6 through the addition of NaOH and enzymes, namely proteases, are added to break down the proteins. Enzymes are most efficient at 64°-70° and temperature reduction or increase will hamper the process.

The mixture is tested every 20 to 30 minutes during the cycle to ensure that the pH level is maintained at 8.9 to 9.6 throughout process by adding NaOH when required. Other mixture factors such as moisture content are also checked during the cycle. The mixture is pumped through a shear pump connected to the tank(s) by piping, either from tank to tank or within the same tank. The pumping continues until the particles have been broken down to less than 120 microns. The pH and temperature remain constant until the protein is in the range of 3.5% to 6.0%, and preferably 4%, and the pH stabilizes at 6.8 to 7.6. This indicates that the proteins have been broken down to amino acids to the extent that is economically viable. Potassium sorbate and sodium benzoate are added then added for stabilization.

The mixture is tested and adjusted to a neutral pH and heated to 95-97° C. while agitating to deactivate the enzymes. Once the enzymes are deactivated the mixture is cooled to less than 35° C. Once cooled, essential elements are added such as 2%-about 4% molasses, about 2% potassium chloride or other potassium sources for a final potassium content of about 1 to about 1.1% potassium, all percentages by weight.

The pH levels are then adjusted to 3.2 to 3.6 to stop fermentation and the product packaged according to end use.

A system for processing blood and feathers to produce a product for use as a fertilizer, feed, and soil amendment by breaking down proteins to amino acids is disclosed. The system includes at least one tank receiving a mixture of keratin and liquid and having an enclosed configuration capable of pressurization. Each tank of the system includes an agitation member, a heating element, and an exterior wall. The system also includes at least one motor, at least one shear pump, at least one filtration system, piping connecting said at least one tank, said at least one shear pump, and said filtration system; and a plurality of valves directing flow of mixture throughout the system. The mixture cycles through said system until a predetermined protein content and pH level are achieved to produce an environmentally-friendly, organic commercial 4-0-1 (nitrogen, phosphate, potash) fertilizer, feed, or soil mmendment that can be used as a liquid or dried and used alone or in combination with other products.

### BRIEF DESCRIPTION OF THE DRAWINGS

Embodiments of the present disclosure will now be described, by way of example only, with reference to the attached Figures, wherein:

FIG. 1 is a schematic illustration of the mixing tank in a single-tank system indicating the addition of hydrolyzed feathers and blood in accordance with the disclosed invention;

FIG. 2 is a schematic illustration of a two-tank system with the arrow indicating the product being pumped from a first tank to a second tank, in accordance with the disclosed invention;

FIG. 3 is a schematic illustration of the product being pumped back to the first tank from the second tank, in accordance with the disclosed invention;

FIG. 4 is a schematic illustration of the product being returned to the second tank after addition of stabilizing additives and product being filtered, in accordance with the disclosed invention;

FIG. 5 is a schematic illustration of the addition of stabilizing additives and product being filtered from the first to the second tank, in accordance with the disclosed invention;

FIG. 6 is a schematic illustration of the addition of additives, final filtration, and delivery to transport receptacle, in accordance with the disclosed invention; and

FIG. 7 is a flow chart illustrating the process flow in accordance with the disclosed invention.

### DETAILED DESCRIPTION OF THE INVENTION

Definitions:

As used herein the term “shear pump” shall refer to any pump or mixing mechanism that reduces and disperses particles into liquid, including but not limited to homogenizer, shear blenders, inline high shear mixers, and specialty pumps that have rollers or multiple blades like a shear pump or homogenizer.

As used herein the term “amino acid feed” shall refer to animal feed, or feed base, consisting of amino acids, potassium, molasses, and vitamins in addition to specialized required nutrients required to meet a specific animal's, fish's or insect's current requirement.

As used herein the term “animal” shall refer to any living organism that feeds on organic matter.

As used herein the term “plant” shall refer to any living organism capable of photosynthesis.

As used herein the term “amino acid product” shall refer to a product for use as a fertilizer, soil amendment, or feed consisting of:
about 4% amino acids,
about 1% phosphate, alone or with the addition of about 0.02% full spectrum vitamin B,
about 2-3% or more of molasses depending on changing nutrition requirements,
About 4% nitrogen, about 3.2% being water soluble nitrogen and about 0.80% being water insoluble nitrogen,
available phosphate (P2O5) about 0.02%, and
soluble potash (K2O) about 1.0%.
Molasses adds to the phosphate in a form not solidifying.

As used herein the term “about” shall refer to a variation of between about 10% and about 15%.

As used herein the term “blood” shall refer to a liquid of only blood or a mixture of blood and water.

As used herein the term “protease” shall refer to enzymes that hydrolyze proteins.

As used herein the term “cycle” shall refer to the time period from loading of the blood/liquid to raising the temperature to deactivate the enzyme.

As used herein the term “run” shall refer to the flow of the mixture through a system from an originating tank, through at least one shear pump, and back to the originating tank. A run can include the flow of mixture from an originating tank, transfer to another tank for processing, and transfer back to the originating tank.

Amino acids are building blocks for proteins and critical to cell function in both animals and plants. Both plants and animals require certain amino acids. Both essential and non-essential amino acids are required in animals as the major component of muscle, tissue, and some fluids. Although non-essential amino acids can be produced by an animal's body, essential amino acids must be provided within the feed, based on the requirements of the animal's body. Amino acids are obtained from consumed proteins broken down by the body. This consumption of protein also produces a substantial amount of waste.

While plants can synthesize the amino acids required to make proteins, these amino acids can also be absorbed. Absorbing amino acids uses less energy and is thus easier on plants in stressful conditions. Amino acids need less water for the function of the plant in photosynthesis, thereby making them advantageous in drier areas. Amino acids require little to no interaction with bacteria or fungus to provide similar plant growth and vigor.

The present invention discloses an efficient, effective, and environmentally friendly amino acid product and process for making the same. Due to the purity of the final amino acid product described herein, all living organisms can use the product to their benefit. Further, amino acid products added to soil are beneficial in that amino acids alter soil structure by altering the microbial production of exoenzymes.

Amino acid feeds are directly absorbed by animals and are therefore more efficient than standard protein sources, such as fishmeal, meat and bone meal, soybean meal, etc. From a volume standpoint, production of the amino acid product in accordance with the invention reduces the feed volume as much as 300% while still producing the equivalent amino acids. Additional benefits are achieved as the disclosed invention produces aspartic acid which, in turn, breaks down other proteins on contact thereby increasing the efficacy of the product. Additionally, any sulfur in the mix is readily available to animal/plant.

The production of organic fertilizer from feathers, or other keratin such as big hair, and blood helps eliminate pollution by eliminating tons of waste that goes to landfills or ends up in sewage treatment facilities. The blood source can be from any mammal and is largely dependent upon availability and proximity to the processing plant.

The amino acid product manufactured as disclosed can be a food source for most animals including fish and invertebrates, making its use as a fertilizer safe to use around ponds, lakes, rivers, and most water ways. Additionally, the products are manufactured from what would normally be waste material, providing additional ecological benefit. Further benefit and savings are obtained by the ability to produce the product with the disclosed method using off-the-shelf commercial equipment already in place in rendering and feed production facilities.

This invention encompasses production of a single product that is equally effective as an organic fertilizer, feed, and soil amendment by uniquely extracting the amino acids from blood and feathers simultaneously in a continuous process. Blood used can be from any available animal including but not limited to chicken, turkey, or fish; but using blood from the source protein is the most economical and financially sound alternative. As the amino acid product contains the same amount of protein as found in feather meal and blood meal but broken down into amino acids, significantly less feed is required. As the amino acids provide immediate and significantly more efficient absorption in animals, birds, insects, and fish, feeds of the present invention require no breakdown in the stomach.

To increase the efficiency of the product, full spectrum B vitamins, molasses, and potassium, all of which are equally beneficial to plants and animal feeds, can be added to the basic amino acid formula. The final product can be the amino acids by themselves or an “amino acid product” as previously defined. Plants benefit from the potassium as an essential nutrient, and the molasses and B vitamins promote beneficial microorganisms and mycorrhizae that enhance phosphorus uptake and create a beneficial microclimate around the plant. Animal feeds also benefit from essential potassium and molasses with B vitamins that promote beneficial microorganisms for improved gut health and absorption. As stated heretofore, the amino acid product is customizable, through use of additives, to meet the needs of the plant or animal.

The use of all thirty-three (33) amino acids help provide the core of the invention's versatility, providing essential benefits for each application including conditioning soil and improving nutrient uptake in plants, animals, fish, and insects. Amino acids require less water for the function of the plant in photosynthesis and some are bio stimulants. Uniquely blending blood and feathers provides a minimum of the 21 essential amino acids as well as at least 12 of the non-essential amino acids, as noted below, for plants and animals:

| | | | |
|---|---|---|---|
| Alanine | Cysteine | lsoleucine | Serine |
| Amino Adipic Acid | Cystathionine | Lanthionine | Taurine |
| Amino Butyric Acid | Ethanolamine | Leucine | Threonine |
| Amino lsobutyric Acid | Glutamic Acid | Lysine | Tryptophan |
| Arginine | Glutamine | Methionine | Tyrosine |
| Asparagine | Glycine | Ornithine | Valine |
| Aspartic Acid | Histidine | Phenylalanine | |
| Citrulline | Homocystine | Proline | |
| Cystine | Hydroxyproline | Sarcosine | |

Due to the process of manufacture, the nitrogen contained within the amino acids is immediately available for plant uptake or animal absorption and ingestion without the use of nitrates. This avoids the issue of the nitrates converting to potentially harmful nitrites. All amino acids can be found in human diets as well as animals. Four of the amino acids, methionine, cysteine, homocysteine, and taurine, provide sulfur while others assist in protein utilization or breakdown for a variety of plant and animal functions.

The final amino acid product can take solid or liquid form. In liquid form, the disclosed amino acid product can be used in drippers, dripper-lines, sprinklers, and micro-emitters, providing foliar and root fertilization. Alternatively, the liquid can be applied directly to the ground, providing the same benefits. The liquid can also be dried with a corn starch or similar carrier and applied as a granule or made as a wettable powder and mixed with a variety of other constituents such as phosphorus for fertilizers, other essential nutrients for feeds, and other elements for bioremediation in soil amendments. Animal and fish feed can be liquid or dried for granular application.

In both liquid and dry form, the disclosed amino acid complex has a pleasing aroma to animals and can be used as a fragrance for a variety of pet foods and other feeds. The amino acids reduce algae in ponds and lakes while providing a healthier food source for the fish and bacteria. The additives increase the health of the fish who will become more active and increase turbulence, thereby assisting in the reduction of the algae.

In the disclosed process, the amino acid product is produced to FDA standards in FDA facilities to ensure safety. The excess heat of the process ensures sterilization of the final product and renders the blood safe.

The system of the present invention produces product high in amino acids by processing keratin and blood. The source of keratin can vary from hair to pig bristles with some sources requiring pretreatment, such as hydrolyzation, prior to use. It should be noted that although hydrolyzed feathers are used herein as an example, other sources of keratin can be used. The system of the present invention includes at least one tank, an agitator, a heating system, a pump, a filter, and a number of valves and pipes. To produce the amino acid product, a combination of keratin, blood, and optional water are introduced into the system and agitated to create a slurry which is then pumped through the system at least one run (the specifics of the method of are described below). Enzymes are added to the slurry in order to facilitate the breakdown of the keratin into amino acids. The enzymes can be added at the beginning of the initial run or during a subsequent run later in the processing cycle after the initial addition. The addition of enzymes, primarily protease, is required to shorten the time required to breakdown the proteins in the keratin into amino acids. Although the blood, when used, does add some inherent enzymes, they are in small amounts and are protease inhibitors vs the protease preferred herein. Protease is the primary enzyme used in the disclosed method due to its ability to break down proteins into amino acids.

The disclosed invention is a closed system that processes a set amount of slurry at a time based on the tank size. The amount of slurry processed in each run can be easily calculated based on tank size, and the amount of additives provided into the slurry are percentages based on the slurry weight and can be determined by those skilled in the art. The slurry continues running through the system until, as outlined below, the process cycle is complete. The process outlined below is directed to the production of the slurry only, and further processing such as drying, freezing, etc. will be well known in the art using commercially available equipment.

During production, various composition parameters of the slurry must be monitored, such as but not limited to pH levels, percentage of additives, protein content, fat content, and content. This monitoring is accomplished by taking samples of the product throughout the production process and can be done manually or automatically, depending on the equipment available. Preferably samples are taken three to five times during a cycle, e.g. every 20 to 30 minutes in a two hour cycle.

Likewise, the switching of the valves can be accomplished manually or as part of a computerized system. Whether one or multiple tanks are used, the process and the criteria as set forth below is applicable. Additionally, although in the dual tank system described below the tanks are labeled a and b, the additives and exit pipe 282 can be on either tank

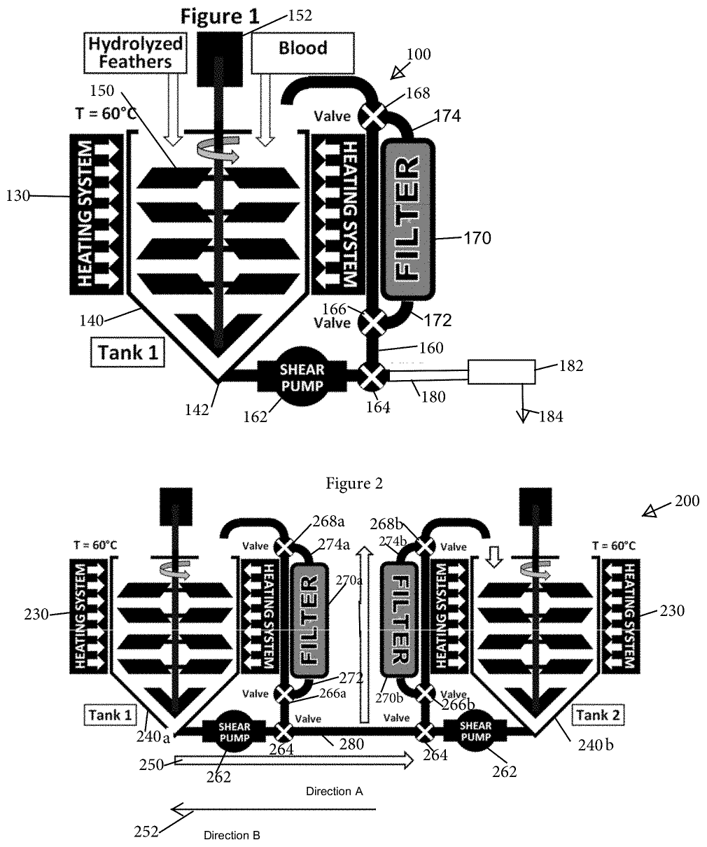

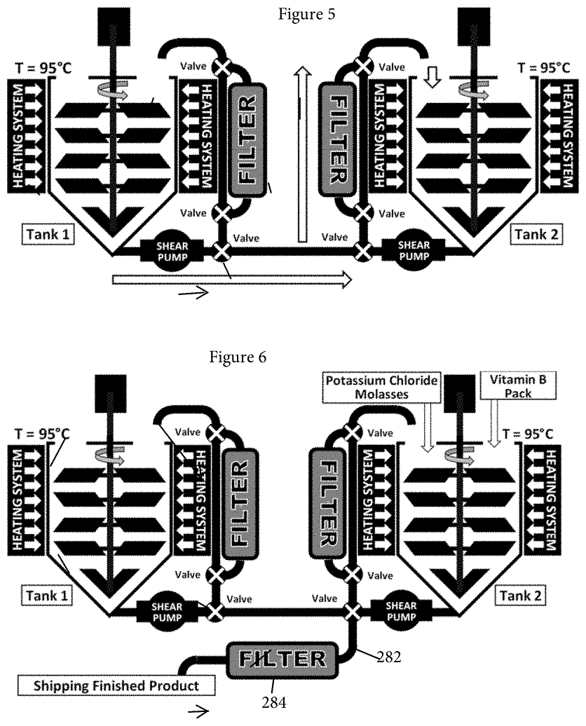

The tank system 100, illustrated in FIGS. 1-6 as examples, consists of a tank 140 having an exterior 141, a heating system 130, and an internal agitator 150 powered by an exterior motor 152. The agitator 150 must be dimensioned to thoroughly mix the contents, including the product adjacent tank wall 141. The product is moved through the system by shear pump 162 that pumps the product through piping 160. The production process can be a single tank process (FIG. 1), a dual tank process (FIGS. 2-6), or a continuous process along multiple tanks (not shown). For best results, each tank in the system is enclosed and pressurized at least 1-2 atmospheres to keep volatile nitrogens in solution. Although there is no actual limit with respect to atmospheres, a 20 atmosphere is a reasonable limit based on standard equipment. Alterations to the atmosphere limit will be known by those skilled in the art. It should be noted that the illustrated design is used for simplicity and any tank that meets the criteria set forth herein can be used. The identifying numbers illustrated in FIG. 1 will be used for both tanks as they are identical units.

Illustrated in FIG. 1 is a single tank system 100 where the product, prepared in accordance with the procedure below, is pumped from the outlet 142 by the shear pump 162, through the valve 164 to the valve 166. The valve 166 is used to control whether the product proceeds directly to valve 168 for additional mixing or is diverted to pipe 172 and through the filter 170 for filtration. The valve 168 is used to determine whether the product sourced back into the tank 140 is from the pipe 160 or the pipe 174 after being directed through the filter 170. The process and criteria, as described below for the double tank system, is achieved by running the slurry through the single tank multiple times.

Although not required in a single tank system 100, the valve 164 (263 in FIGS. 2-6) provides the added benefit of easy extension to a two, or multi, tank system 200.

Additionally, once the process is complete, valve 164 serves as the exit valve for transferring the amino acid product from the single tank system 100. The valve 164 directs the slurry through pipe 180 to the filter 182 where it exits 184 to a storage container (not illustrated). In FIGS. 2-6 a two-tank system 200 is illustrated. It should be noted that although multiple tanks allow a small degree of added control as to additives and processing time, a single tank will produce the same product. The selection between a single tank, dual tanks, and multiple tanks, either connected or independent, will be dependent upon space, available equipment, end use, and quantities and formulations required and will be evident to those skilled in the art. The two or more tanks will ensure more complete digestion through the transfer from one tank to another.

The numbering applied to FIG. 2 is applicable to all figures illustrating multiple tanks with only additional components not illustrated in prior figures receiving new numbering.

As illustrated in FIG. 2, the slurry in a multiple tank system is pumped in Direction A via piping 250 to a shear pump 262 through the valve 264a that, at this stage is directing product flow through pipe 280 to valve 264b. The valve 264b directs the flow toward valve 266b and up to valve 268b after which it is directed into the second tank 240b. As with the single tank system 100, the slurry is directed at valves 266a and 266b either to bypass the filter 270 to valve 268a and 268b or to flow through the filter 270.

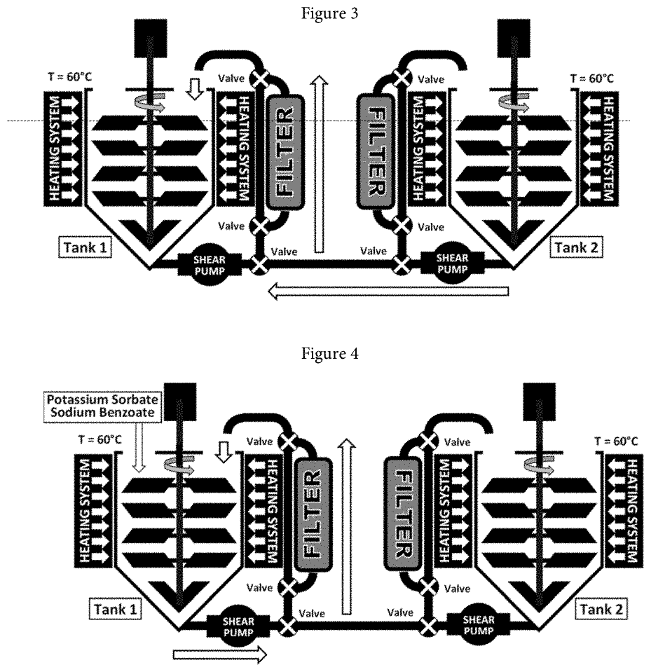

As illustrated in FIG. 3, once the slurry is in the second tank 240b under heat and agitation, it is pumped back into the first tank 240a via the shear pump 262b by switching valve 264b to direct flow along pipe 280. Valve 264a is changed to direct the flow up through valve 266a to valve 268a and bank into the tank 240a. This is agitated and recirculated though the shear pump for approximately two hours while maintaining a pH 8.9-9.6 in order to optimize protein break down. The pH regulation process is discussed in more detail below. Different types of keratin may require more agitation to break down the outer layers of the feather, hair, or other keratin source, as well as more time in a shear pump to reduce particle size as well as potential additions of sodium sulfite to assist in breaking down proteins.

The shear pumps 262a and 262b, or their equivalent, are used to reduce particle size to between 10 to 100 microns. Reducing particle size to less than 100 microns is essential for complete breakdown of the proteins and isolating non-protein constituents.

The product can be pumped back and forth between the tanks 240a and 240b, as illustrated by Direction A and Direction B arrows, or can be pumped and filtered in a loop in a single tank 140. Dual tanks can also be designed to enable one to be shut down for cleaning or maintenance while enabling the remaining tank to continue operation. Typically, however, facilities would have multiple systems and the ability to shut one down for maintenance and/or cleaning while the others continue to process.

As illustrated in FIG. 6, when processing is complete, valves 266a and 266b are changed to direct the product flow through the filters 270a and 270b to exit using pipe 274a and 274b. The 120-mesh filters 270a and b are added to the process to remove any remaining particles over 120-mesh. Valve 268a and 268b are changed to receive the product from pipe 274a and 274b and direct it back into the tank 240a and 240b. Any product in tank 240b is pumped back into tank 240a where the product is stabilized as described in detail below. Once stabilized, the finished amino acid complex is then pumped from the tank 240b, or 140, through pipe 282 and a final filter 284 and placed in railcars, tankers, or totes for distribution (FIG. 6). Filter residue can be recirculated or used as a soil amendment.

To begin the production process of the amino acid product of the present invention, hydrolyzed feathers, or other keratin sources, are pressed, if required, prior to introduction into the tank system to obtain a moisture content in the range of 45-60%, and preferably around 50%, and lower the fat content to 1-4%. The blood is introduced into the tank prior to addition of the keratin and is agitated alone in the tank. To prevent coagulation of the blood caused by rapid heating, the temperature is slowly raised to 30°−40° C. After agitating and warming the blood to 30°−40° C., the keratin is slowly added to the blood in the tank system. After thorough mixing of the keratin and blood, typically 15-20 minutes, a sample is taken from the tank and tested to confirm the moisture content of the mixture. A moisture content of 58-62% is desirable to allow for proper flow of the mixture through the processing cycle. If necessary, water is also added at this time to achieve the desired moisture content. Further during the processing cycle, preferably around the half-way point of the processing cycle, additional moisture content readings are taken to ensure proper flow.

While the amount of keratin and blood introduced into the system is dependent upon tank size, the mixture composition is approximately 1%-40% blood, with the remaining 99%-60% being hydrolyzed keratin. With any mixture composition, the desired moisture content is 60%. As sufficient amounts of blood are not always available to reach the 60% moisture content, water can be added to bring the moisture content to about 60%. Typically, the addition of water is not necessary unless the mixture composition is around 80% or greater feathers to 20% or less blood. The minimum quantity of blood required is between about 1%-3% with a maximum of 40% to achieve the optimal 4% protein of the final product. The heating process continues once the keratin is added to reach the final operating temperature of 64°−70° C., the optimum range for the subsequently added enzymes to reduce the proteins to amino acids.

Although not optimal, if blood is unavailable, only a keratin and water combination can be used, since keratin has the same protein content as blood; however, blood provides iron and other minerals as well as additional amino acids not contained in keratin and beneficial to the final product. The use of blood further provides the benefit of eliminating the disposal of a potentially dangerous waste product. The slurry remains under constant agitation during the addition of any component. If no blood is available, enough water is added to keratin to achieve the 60% moisture content.

Blood and keratin are nearly identical in protein content; however, most keratin requires hydrolysis in order for the protein to be more accessible to break down to amino acids in this process. The balance between the water and the protein source must be regularly checked through the measurement of protein within samples taken from the tank in order to reach the final result of about 4% protein. These measurements can be taken manually or by meters installed within the tank system. If protein measurements are low, more feathers can be added to the system.

The composition of the mixture being about 1%-40% blood and 99%-60% hydrolyzed keratin provides flexibility in manufacturing, volume of keratin source, and adjustments to amino acid compositions. The variation from about 1%-40% provides manufacturing advantages as to the availability of blood and choice of keratin source as well as the ability to focus on specific amino acid compositions for differing feed and fertilizer variations.

Water is added when the volume of blood is lower in order to reach, and maintain, a moisture content of between about 58% and about 62%, with about a 60% moisture content being preferable. An initial moisture content below that range creates a sludge, while over that range requires additional heating to “boil down” the additional moisture. Staying within the desired moisture range reduces manufacturing time and energy costs.

As illustrated in FIG. 2, the initial benchmark reading of temperature, pH, and protein digestion are made as the slurry is heated within the tanks 240 to the optimum of about 64°-70° C. (154° F.). Although the temperature can be above or below the optimum, 64°-70° C. is the range within which the enzymes are most efficient in breaking down the proteins. As the slurry is being heated to optimal temperature, the pH of the heated slurry is adjusted to a pH of 8.9-9.6 through the addition of sodium hydroxide (NaOH) flakes, or its equivalent, to provide the acid required to enable the enzymes to work. The range is viable, but always targeting a pH of 9.0 is most effective and can accelerate decomposition, depending on humidity, ratios of feathers to blood and minor differences in moisture content. As the pH will naturally lower during the process to a 6.5-6.7 pH as the enzyme reduces proteins, the pH should be constantly check and maintained in the above range, through the addition of NaOH, to account for material variation and variable humidity. It is at this stage of heating that the enzymes, as described hereinafter, are added.

Prior to adding the enzymes, the fat content of the solution is checked in order to determine whether lipase is required. The percentage of the enzymes required is largely dependent upon the desired speed of process completion. The amount of enzyme can be adjusted to make the process faster or slower for economic or processing reasons. Doubling the enzyme typically halves the time to complete the process, halving essentially doubles the process time demonstrating a nearly linear relationship between enzyme and time to process. The addition of lipase facilitates the processing of fats and oils in the slurry to achieve desired ratios for the final product.

The enzymes generally used are lipase and protease with the ratio of lipase to protease varying dependent on fat content. The percentage is typically about 2% protease and about 0.0% lipase to about 2% protease and about 0.5% lipase for unusually high fat content of about 30%. Most batches will require no lipase and typically no greater than about 2% protease and about 0.1% lipase. To assist in breaking down the quills about 0.1% sodium sulfite can be added for chicken feathers and about 0.2% for turkey feathers or pig bristles. This will vary depending on the percentage of blood and/or water vs. keratin and the keratin being used with any variations being known to those skilled in the art. All changes must result in a final amino acid solution that is about 3.5% to about 6.0% protein with an optimal percentage of about 4% protein.

Once the slurry has reached the benchmark readings (pH 8.9-9.6), a least a portion of the enzymes, primarily protease, are added. As noted above, there is a direct correlation between the percentage in weight of enzymes and the completion time. For example, 2% enzymes by weight will produce final product in two hours; 1% will produce product in four hours; and 4% in one hour. Enzymes are the most expensive element in the product and the percentages are economic issue.

The point of addition of the enzymes can vary with about 50% being added at upon reaching the optimal pH level and the remaining about 50% after one fourth the process time has passed. The object is to maintain the pH at the optimal level which is best accomplished by constant testing, with additional enzymes and NaOH being added as necessary.

In the event there is a fat content greater than about 12% raw or about 4% pressed, the fat content can be counteracted by the addition of about 0.2% lipase. Additionally, if the ratio of blood to keratin is greater than about 30%, lipase should be added at up to about 0.5% in addition to the about 2% protease to cause the fat to go into the solution rather than settling on top. When using feathers, about 0.1% of the total weight sodium sulfite for chicken feathers and about 0.2% for turkey feathers is added assist in the breakdown of the quills. No matter what keratin is used, the same process is followed, thereby using what is normally considered a waste product and turning it into a usable product.

In instances where the fat content cannot be completely countered by the lipase, or sufficient lipase cannot be used, any remaining fat can also be skimmed off at the end of the process.

The completion of the process is determined when the pH stabilizes at 6.8-7.6 and the liquid achieves over about 99% protein conversion to amino acids. Stabilization occurs when the pH stops dropping below 6.8, indicating that the protein is reduced as far as economical, The process takes approximately two hours to complete based on the foregoing temperature and enzyme percentage (about 2%). As the enzymes break down the contents, reduction of the percentage of enzymes increases the time between initialization and completion. For example, adding about 2% enzymes gives the 2-hour completion; about 1% enzymes will double the processing time to approximately four hours and adding only about 0.5% enzyme will increase the time to approximately 8 hours.

At the process run completion point, the product is ultimately pumped into tank 240a (dual tank) or tank 140 (single tank) for stabilization. Potassium sorbate, about 0.1% and sodium benzoate, about 0.1%, are added to stabilize the liquid solution, thereby increasing shelf life. The pH is checked and adjusted, if necessary, to a neutral or slightly acidic. The liquid solution is now heated to about 95° C. (203° F.) in tank 240a and agitated for about 15-25 minutes or until all enzymes are deactivated. Measurements are again taken to ensure enzymes are inactive, and the entire solution allowed to cool in tank 140 or tank 240b. Essential elements which enable the finished product to function as a fertilizer, feed, and/or soil amendment can be added at this time. The temperature is lowered to 35° C. (95° F.) and about 2%-about 4% molasses, about 2% potassium chloride or other potassium sources for a final potassium content of about 1 to about 1.1% potassium by weight. A 0.02% full spectrum vitamin B pack are added while the liquid solution is being agitated for about 30 minutes. 0.1% potassium sorbate and 0.1% sodium benzoate can be added to stabilize the liquid solution. This step is optional and is determined by routine sample testing and may not be required adjusting the finish product pH to under 3.8 pH.

The amino acid product is complete when the protein content is verified at about 4%, and pH of 6.5-6.7. The pH is then adjusted to 3.2-3.6 to stop fermentation and all biological processes until used as a fertilizer, soil amendment, soil reclamation product, or feed. Citric acid or phosphoric acid preferred. Lowering the pH below 3.8, preferably 3.6-3.2, eliminates fermentation which can cause unwanted outgassing and odors. The lower pH also controls or prevents other undesired biological processes from occurring insuring long shelf life and stability in shipping and warehousing.

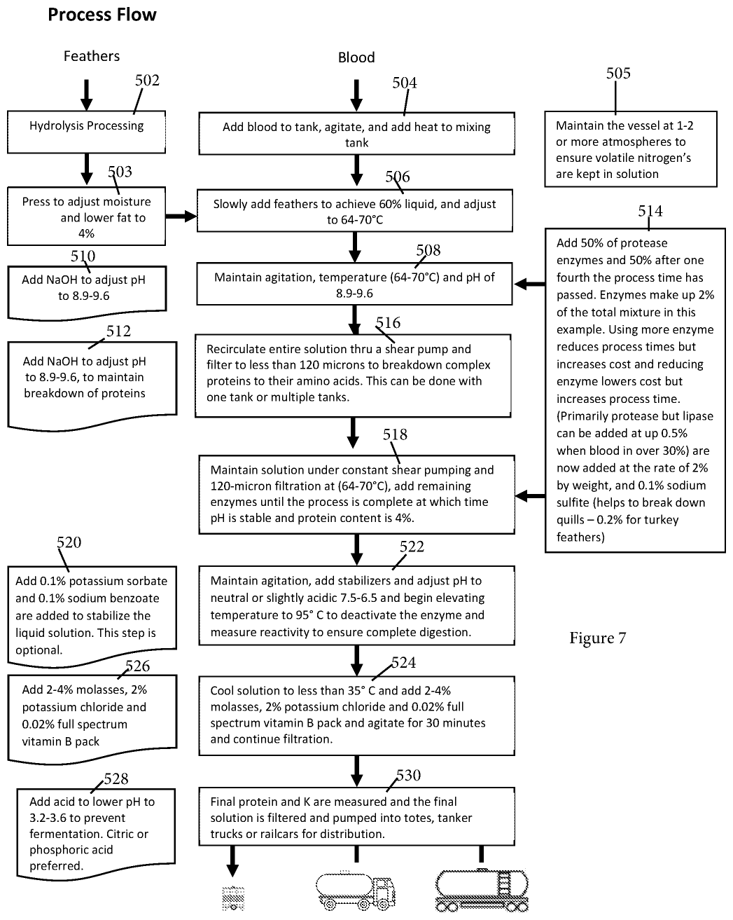

The production process is illustrated in the flow chart of FIG. 7:

### Process Flow

1. Press hydrolyzed feathers 502 to adjust moisture to around 50% and fat content to 4% fat 503.
2. Add an amount blood to the tank depending on the desired ratio of blood to keratin 504.
3. Agitate blood and begin adding heat 504.
4. Close tank and maintain a pressure of 1-2 of more atmospheres to keep all volatile nitrogens in solution 505.
5. Slowly add the feathers until the desired keratin to blood ratio is achieved, and add water to achieve moisture content of around 60% 506.
6. Adjust the solution temperature to 64-70° C. 508.
7. Add NaOH to adjust pH to 8.9-9.6 508. This can vary with keratin type (hair, feathers, etc.) 510
8. Check pH and add NaOH if necessary, to maintain pH 512
9. Add enzymes, either at 50% initially, and 50% after one fourth the process time has passed or 100% initially 514.
10. Pump the solution through a shear pump (homogenizer) to reduce particle size to less than 120 microns to facilitate break down proteins to amino acids 516.
11. Run the solution under constant shear pumping and filtration to ensure all particles are less than 120 microns 518.
12. Add additional NaOH to maintain a high pH (8.9-9.6) to maintain breakdown of proteins 512.
13. Maintain the moisture content around 60%, the pH level at 8.9-9.6, and temperature at 64-70° C. continuing until the process is complete at which time pH is stable and protein content is 4% 518.
14. Optionally add 0.1% potassium sorbate and 0.1% sodium benzoate to stabilize the liquid solution 520.
15. Agitate and heat solution to 95-97° C. to deactivate the enzyme. Typical times are one to two hours at which time the protein content is check to ensure no activity 522.
16. Cool solution to less than 35° C. 524.
17. Add 2-4% molasses, 2% potassium chloride and 0.02% full spectrum vitamin B pack while agitating for 30 minutes 526.
18. Adjust pH to 3.2-3.6 to stop fermentation and all biological processes until used as a fertilizer 528.
19. Measure final protein and potassium (K) amount, and filter and pump the final solution into totes tanker trucks or railcars for distribution.

, The finished product is an organic commercial 4-0-1 (nitrogen, phosphate, potash) fertilizer or soil mmendment and a feed that can be used as a liquid or dried and used alone or combined with other feeds. Examples of use are feed for black fly larva and all insects, chickens and other foul, all fish, mammals, reptiles, crustaceans; basically, most all living things and microorganisms. This product can be safely used around water because it is suitable as food for fish, reptiles, invertebrates and amphibians.

What is claimed is:

1. A method of producing a product for use as a fertilizer, feed, and soil amendment by breaking down proteins to amino acids comprising the steps of:
a. placing liquid in a tank system of at least one tank, each of said at least one tank containing a heating system and an agitator;
b. agitating and heating said liquid to an initial predetermined temperature;
c. adding keratin with said liquid in said at least one tank until a mixture having a predetermined composition percentage of liquid and keratin is achieved;
d. testing said mixture to obtain a moisture content percentage, wherein a predetermined desired moisture content percentage is in the range of 58-62%;
e. adjusting temperature of said mixture to a predetermined temperature;
f. adding NaOh to bring said mixture to a pH level of 8.9 to 9.6;
g. testing of said mixture for fat content;
h. adding enzymes to said mixture;
i. maintaining said pH level at 8.9 to 9.6 throughout processing by adding NaOH when required;
j. pumping said mixture through a shear pump connected to each of said at least one tank by piping;
k. continuing to pump said mixture through said shear pump until particles within said mixture are less than a predetermined size;
l. maintaining said pH level and said temperature constant until protein content within said mixture is at predetermined percentage and said pH stabilizes at 6.8 to 7.6;
m. adding potassium sorbate and sodium benzoate to stabilize said mixture;
n. testing said mixture and adjusting to a neutral pH;
o. heating said mixture and agitating until all enzymes are deactivated;
p. cooling said mixture;
q. adding to said cooled mixture essential elements;
r. adjusting said pH level to 3.2-3.6 to stop fermentation;
s. pumping said mixture from said at least one tank;
wherein said product is packaged according to end use.

2. The method of claim 1 wherein said liquid is blood.

3. The method of claim 1 wherein said keratin is feathers.

4. The method of claim 1 wherein each of said at least one tank is pressurized to at least 1-2 atmospheres.

5. The method of claim 1 wherein said at least one tank is multiple tanks connected by valves and piping, each of said multiple tanks having a shear pump.

6. The method claim 1 wherein said predetermined percentage is 1-40% liquid and 60-99% keratin.

7. The method of claim 1 further comprising adding water to said mixture to adjust said moisture content percentage to within said desired moisture content percentage range.

8. The method of claim 1 wherein said predetermined temperature is 64°-70°.

9. The method of claim 1 wherein said predetermined size of said particles is less than 120 microns to facilitate protein breakdown.

10. The method of claim 1 wherein said predetermined percentage of said protein is 3.5% to 6.0%.

11. The method of claim 1 wherein said predetermined percentage of said protein is 4%.

12. The method of claim 1 wherein said enzymes are protease to break down proteins.

13. The method of claim 1 wherein said enzymes are lipase to cause fat to disperse within the solution.

14. The method of claim 3 further comprising the step of breaking down feathers by adding sodium sulfite.

15. The method of claim 1 wherein said essential elements are molasses, potassium and full spectrum vitamin B pack.

16. The method of claim 12 wherein said molasses is 2%-4%; said potassium content 1-1.1% by weight, and said vitamin B pack is 0.02%

17. The method of claim 1 wherein said initial predetermined temperature is 30°-40° C.

18. A method of producing a product for use as a fertilizer, feed, and soil amendment by breaking down proteins to amino acids comprising the steps of:
a. placing blood in a tank system of at least one tank, each of said at least one tank being an enclosed tank pressurized to at least 1-2 atmospheres and containing a heating system and an agitator;
b. agitating and heating said blood to an initial predetermined temperature of 30°−40° C.;
c. mixing pressed keratin with said blood until a mixture having a composition of 1-40% blood and 60-99% keratin is achieved;
d. testing said mixture to obtain a moisture content percentage;
e. adding water to said mixture to adjust said moisture content percentage to be in the range of 58-62%;
f. adjusting temperature of said mixture to 64°-70°;
g. adding NaOH to bring said mixture to a pH level of 8.9 to 9.6;
h. testing of mixture for fat content and adding lipase;
i. adding protease to said mixture;
j. maintaining said pH level at 8.9 to 9.6 throughout process by adding NaOH when required;
k. pumping said mixture through a shear pump connected to each of said at least one tank by piping;
l. continuing to pump said mixture through said shear pump until particles within said mixture are less than 120 microns to facilitate protein breakdown;
m. maintaining said pH level and said temperature constant until protein content within said mixture is 4% and said pH stabilizes at 6.8 to 7.6;
n. adding 0.01% potassium sorbate and 0.1% sodium benzoate to stabilize said mixture;
o. testing said mixture and adjusting to a neutral pH;
p. heating said mixture and agitating until all enzymes are deactivated;
q. cooling said mixture;
p. adding to said cooled mixture essential elements of 2%-4% molasses, 1-1.1% by weight potassium and 0.02% full spectrum vitamin B pack,
r. adjusting said pH level to 3.2-3.6 to stop fermentation; and
s. pumping said mixture from said at least one tank;
wherein said product is packaged according to end use; and
wherein product is an environmentally-friendly, organic commercial 4-0-1 (nitrogen, phosphate, potash) fertilizer, feed, or soil mmendment that can be used as a liquid or dried and used alone or in combination with other products.

19. A system for the production of an amino acid product for use as a fertilizer, feed and soil amendment comprising:
at least one tank, each of said at least one tank receiving a mixture of keratin and liquid and having an enclosed configuration capable of pressurization and comprising:
an agitation member, said agitation member agitating said mixture to facilitate the breakdown of protein to amino acids,
a heating element, said heating element heating said mixture to facilitate the breakdown of protein to amino acids, and
an exterior wall;
at least one motor, said at least one motor facilitating the function of said agitating member within said at least one tank;
at least one shear pump, said at least one shear pump pumping said mixture through said shear pump until particles within said mixture are less than a predetermined size;
at least one filtration system, said filtration system filtering said mixture;
piping connecting said at least one tank, said at least one shear pump, and said filtration system; and
a plurality of valves, said valves directing flow of said mixture throughout said system;
wherein said mixture cycles through said system until a predetermined protein content and pH level are achieved to produce an environmentally-friendly, organic commercial 4-0-1 (nitrogen, phosphate, potash) fertilizer, feed, or soil mmendment that can be used as a liquid or dried and used alone or in combination with other products.
